(19) United States
(12) Patent Application Publication
(10) Pub. No.: US 2004/0033379 A1
(43) Pub. Date: Feb. 19, 2004

(54) Low permeability materials and coatings

(75) Inventors: Jamie C. Grunlan, Pasadena, CA (US); Yi-Hung Chiao, Temple City, CA (US); Kai Li, Diamond Bar, CA (US); Mark Licon, Diamond Bar, CA (US); Ramin Heydarpour, Beverly Hills, CA (US)

Correspondence Address: Oppenheimer Wolff & Donnelly LLP, Suite 700, 233 Wilshire Blvd., Santa Monica, CA, 90401, US

(73) Assignee: Avery Dennison Corporation

(21) Appl. No.: 10/459,025

(22) Filed: Jun. 10, 2003

Related U.S. Application Data
(60) Provisional application No. 60/389,755, filed on Jun. 17, 2002.
(60) Provisional application No. 60/388,601, filed on Jun. 12, 2002.

(51) Int. Cl. B32B 27/00

(52) U.S. Cl. 428/515; 428/500

(57) ABSTRACT

One aspect of the invention relates to a new dual-layered construction that provides advantageous oxygen barrier properties. Another aspect of the invention is a multilayer film that has advantageous oxygen and/or moisture barrier properties. The film may be fully-organic. The film may also be primarily water-based. At least some embodiments of the film can be produced using wide-web, roll-to-roll processing. Specific example applications for uses of the film include dried food, pharmaceuticals, liquids, lidstock, cheese, meat, health & beauty, and coffee packaging, among many others. Another aspect of the invention is a water-based, fast curing coating composition that provides a high barrier against oxygen and moisture permeation. In one embodiment, the coating comprises special PVDC copolymer compositions with good oxygen barrier (OTR<1 cc/m² day) and high moisture barrier (MVTR<0.5 g/m² day). As one example, the coating may be used to produce a flexible, high clarity, barrier film for packaging.

### RELATED APPLICATIONS

This application claims priority from U.S. Provisional Patent Application No. 60/389755, which was filed on Jun. 17, 2002 and which is hereby incorporated by reference in its entirety, and from U.S. Provisional Patent Application No. 60/388601, which was filed on Jun. 12, 2002 and which is also hereby incorporated by reference in its entirety.

### BACKGROUND OF THE INVENTION

1. Field of the Invention

The present invention relates to low permeability materials and, in particular, to barrier films.

2. General Background and State of the Art

PVOH and EVOH polymer materials may be used as oxygen barrier materials in various applications, such as food, pharmaceutical and health and beauty packaging. However, the water sensitivity of these materials has limited their use. To reduce the water sensitivity, a barrier film may have a multilayer construction. The film may be made by, for example, a co-extrusion process.

A barrier film may also need to have other properties. For example, a number of packaging applications (e.g., fresh baked goods, pharmaceuticals, toothpaste, etc.) require a relatively low Oxygen Transmission Rate (“OTR”) of approximately <5 cc/m² day, and/or a Moisture Vapor Transmission Rate (“MVTR”) of approximately <0.5 g/m² day.

To meet OTR and MVTR requirements, opaque, metalized plastic films have been used. These films are relatively inexpensive, but they are not transparent. As a more-expensive alternative, transparent SiOx-coated plastic films may sometimes be used. However, the cost of SiOx-coated plastic films is often too high for many commercial applications.

Considering now some barrier materials that have been proposed:

U.S. Pat. No. 4,684,573 describes an extruded film with multiple layers of poly(vinylidene chloride) PVdC and ethylene-vinyl alcohol (EVOH) that has low oxygen transmission rates (OTR) over a wide range of humidity conditions.

EP 0 355 982 A2, uses a hydrolyzed ethylene-vinyl acetate (EVAc) film (that contains vinyl alcohol as a result of the hydrolysis) that is further irradiated to create free radicals capable of scavenging oxygen for several months. This “scavenging” film actually has an OTR of essentially zero for several days and then eventually plateaus around 2 cc/m² day when tested at 25° C. and 0% RH. The moisture vapor transmission rate (MVTR) of this film is 15-20 g/m² day. This film is not a multilayer construction.

U.S. Pat. No. 5,225,288 describes a multilayer construction that uses poly(vinyl alcohol) (PVOH) and PVdC in the same manner as the current invention. An OTR of 1-4 cc/m² day is achieved at 25° C. over a range of humidity (0-100%). MVTR of this film is 1.7-2.6 g/m² day at 38° C. and 90% RH. The construction is coated symmetrically on both sides of the substrate simultaneously. This film uses a solvent-based PVdC.

U.S. Pat. No. 5,730,919 describes an extruded multilayer film that uses EVOH as the low OTR layers and polypropylene (PP) as the low MVTR layers. The OTR of this film can be as low as 1.5 cc/m² day at 25° C. and 0% RH. The MVTR of this film is 10-15 at 38° C. and 100% RH.

EP 0 951 947 A1 describes a UV-cured resin sandwiched between two substrate layers with an OTR of 4 ccm² day and MVTR of 0.5 g/m² day (temperature and humidity conditions were not specified).

U.S. Pat. No. 5,759,702 uses multiple layers of PVdC latex with varying concentrations of additives to achieve an OTR of 2.4 cc mil/m day (test conditions not specified). MVTR is not reported for the film in this patent. There is no extra layer added to lower the OTR. The construction is based on only one chemistry.

EP 0 962 506 A1 describes a film that is comprised of PVOH laminated between polyolefin layers to achieve an OTR as low as 1 cc/m² day at 20° C. and 85% RH. Polyolefin (e.g., PP or PE) is used as a replacement for PVdC.

U.S. Pat. No. 5,935,664 describes a paper-based (e.g., paperboard) packaging material that uses polyvinylpyrrolidone (PVP) as the low OTR layer capped with PVdC. There is no sandwich of layers. This material's OTR is not described, but the MVTR is 3.9 g/m² day at 38° C. and 90% RH.

In U.S. Pat. No. 6,364,987 B1 PVOH is combined with PP to achieve an OTR of 1.2 cc/m² day at 20° C. and 90% RH. This film is stretched to induce a high level of crystallinity in PVOH that will lower its sensitivity to humidity.

### INVENTION SUMMARY

The present invention relates to barrier materials and coatings. As described in the Detailed Description, one aspect of the invention relates to a new dual-layered construction that provides good oxygen barrier properties.

In one aspect of the invention, transparent, high barrier packaging films that provide superior oxygen and water vapor resistance are provided. The material includes a unique all-organic multilayer coating on a traditional substrate film (such as PET). The system offers significant flexibility—both the substrate film and barrier properties can be tailored to meet specific customer needs.

Another aspect of the invention is a multilayer film that has advantageous oxygen and/or moisture barrier properties. The film may be fully-organic. The film may also be primarily water-based. At least some embodiments of the film can be produced using wide-web, roll-to-roll processing. Specific example applications for uses of the film include dried food, pharmaceuticals, liquids, lidstock, cheese, meat, health & beauty, and coffee packaging, among many others.

Considering another aspect of the invention, displays based upon liquid crystal (LCD) technology suffer from performance degradation as moisture permeates the liquid crystal. A barrier film with a MVTR<0.1 g/m² day (at 35° C. and 90% RH) will provide enough protection to allow high performance to continue for years, rather than days or weeks. Furthermore, a film with this barrier level that can be processed using standard roll coating techniques offers a low cost alternative to sputtered ceramics (e.g., SiOx) that are typically used to achieve this barrier.

Another aspect of the invention is a coating composition that provides high barrier against oxygen and moisture permeation. The coating may be water-based and/or fast curing. In one embodiment, the coating comprises special PVDC copolymer compositions with good oxygen barrier (OTR<1 cc/m² day) and high moisture barrier (MVTR<0.5 g/m² day) properties. As one example, the coating may be used to produce a flexible, high clarity, barrier film for packaging.

The coating typically includes special synergistic components to combine with vinylidene chloride to form a high gas barrier crystalline PVDC copolymer layer on flexible plastic film surfaces. Among the components helpful for enhancing PVDC gas barrier performance, methyl acrylate and methyl methacrylate were identified as the most effective ones at room temperature as well as elevated temperatures (e.g. approx. 40° C.).

Water emulsion or latex of these P(VDC-co-MA) and P(VDC-co-MMA) compositions also showed exceptionally efficient water desorption as monitored by TGA, which is crucial in obtaining high barrier coating under high speed, roll-to-roll continuous operation conditions.

As an alternative, the oxygen barrier and moisture barrier coatings may be employed individually rather than in combination with each other. Each coating may alternatively be combined with other coatings, to provide specific properties as desired for a particular application.

The invention is not limited to the description in this Summary. Other aspects, details and alternatives to this invention will become apparent in the Detailed Description, attached exhibits, and claims.

### BRIEF DESCRIPTION OF THE DRAWINGS

FIG. 1 demonstrates the ability of clay to reduce the water susceptibility of the water-soluble terpolymer

FIG. 2 illustrates the chemical structure of low OTR terpolymer containing vinyl alcohol, vinyl acetate, and itaconic acid units (shown from left to right);

FIG. 3 is a generalized scheme of a fully organic, high barrier film for packaging;

FIG. 4 illustrates the chemical structure of relatively low MVTR Topas cyclic olefin copolymer (COC);

FIG. 5 illustrates the cross-section of a high barrier film full construction, taken with an optical microscope.

FIG. 6 illustrates comparative oxygen and moisture barrier performance of packaging films, with an example of the present invention being labeled “Avery”;

FIG. 7 is another comparative chart;

FIG. 8 is a schematic of the reaction between maleated Topas and the hydroxylated portion of the terpolymer;

FIGS. 9 and 10 are cross-section diagrams of three and five layer constructions, respectively;

FIG. 11 is a multilayer construction; and

FIG. 12 is another a multilayer construction.

### DETAILED DESCRIPTION OF A PREFERRED EMBODIMENT

Dual Layer Barrier Coating Construction

In one embodiment of the invention, a dual-layer construction is made from two wet-coatable solutions—an aqueous solution and an organic solution—which were coated on a PET substrate. This dual-layered construction provides good oxygen barrier (OTR) properties.

This flexible, multilayer coating can potentially be applied to nearly any substrate to meet customer specifications. Multilayer construction can be tailored to provide barrier to only one species (i.e., water or oxygen), while allowing moderate permeability to the other.

Some embodiments of compositions offer window-like transparency (% T>92 and clarity>99.5%).

The following are examples of applications for the present technology: Transparent food packaging—products such as snack chips and coffee, now packaged in opaque metalized plastic bags, will be more dramatically displayed with Avery Dennison's transparent film. Pharmaceutical packaging—tablets, capsules and gel-caps can gain longer shelf life and extended protection form water and oxygen. Health and beauty packaging—available for products such as toothpaste and lotions.

A PVOH based terpolymerterpolymer, poly(vinylalcohol-co-vinyl acetate-co-itaconic acid), exhibits excellent oxygen barrier properties (an OTR of approximately 0.04 cc/m² day in one embodiment), which is comparable with the control of PVOH (an OTR of approximately 0.03 cc/m² day, 98% hydrolized) at 23° C. and 2% humidity conditions. In order to preserve the integrity of the coating at higher humidity condition, a hydrophobic coating was selected to be coated on these two PVOH based coatings. Topas 8007 was selected as a protective layer. With careful selection of an organic solvent, the casted polymer solution does not affect the preformed terpolymerterpolymer and the PVOH coating, and good OTR properties are preserved for the case of terpolymerterpolymer.

Results showed a 2 mil PET film coated with the terpolymer and Topas protective coat gave OTR of 0.1 cc/m² per day at 40° C. and 35% RH conditions. The control of PVOH with Topas had an OTR of 4.07 cc/m² per day under the same conditions, which indicates that the synergy effect between Topas polymer and the terpolymer is different than that between Topas and PVOH polymer.

The combination of this terpolymer/Topas dual layer construction with water based PVDC coating produces a coating that has excellent moisture barrier properties (MVTR) due to the synergy effect.

For further background to this aspect of the invention, the following references are of interest: U.S. Pat. No. 6,203,923B1; U.S. Pat. No. 5,496,295; U.S. Pat. No. 5,730,919; EP0802218 A2; EP0951947A1; EP0962506A1; EP0355982A2; U.S. Pat. No. 5,935,664; and U.S. Pat. No. 5,225,288.

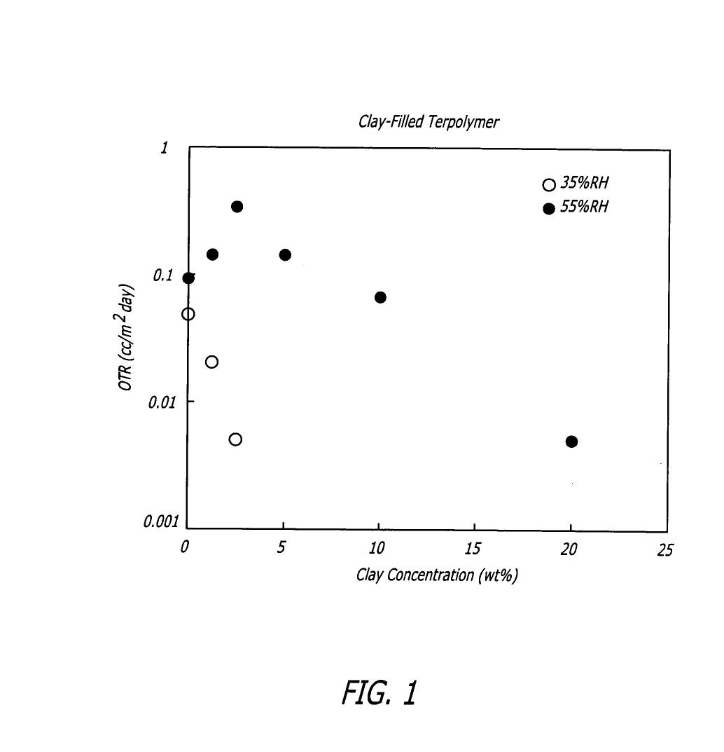

Concerning another aspect, FIG. 1 demonstrates the ability of clay to reduce the water susceptibility of the water-soluble terpolymer. The films represented here are 6 μm of terpolymer on 2-mil PET with no protective layer (e.g., Topas). This type of film could be used by itself for high oxygen barrier applications in low to moderate humidity applications (i.e., % RH<60). All samples were measured at 230° C. The initial rise in OTR at 55% RH is likely due to breaking up of the internal hydrogen bonding of the terpolymer, which hinders its barrier performance. This initial “degradation” of the terpolymer structure is not outweighed by the beneficial tortuous path created by the clay until approximately 5 wt % is added. This effect is not observed at 35% RH due to a lower concentration of water present to plasticize the terpolymer.

Multilayer “Sandwich” Constructions with Low Oxygen and Moisture Permeability

Considering now a second embodiment, a fully-organic, primarily water-based multilayer film can be produced at lower cost than SiOx-coated film and with better performance than metalized plastic. The film can be produced using wide-web, roll-to-roll processing. Specific example applications for the film include dried food, pharmaceuticals, liquids, lidstock, cheese, meat, health & beauty, and coffee, among many others.

In one embodiment, a transparent (% T>92), all-organic multilayer film has been developed with oxygen and moisture barrier better than metalized plastic and with a cost lower than SiOx-coated plastic film. This specific composition of layers (i.e., the order of deposition, layer thickness, and total number of layers) and the low OTR (approximately <2 cc mil/m² day) and MVTR (approximately <0.3 g mil/m² day) at 35° C. and 90% RH that are achieved is novel. At this level of performance, this film is the best overall all-organic system currently available in the literature (i.e., journal articles and patents).

There are three exemplary primary constructions that produce this desired level of barrier performance: (1) PVOH-based terpolymer covered by some type of tie layer to promote wetting (which could be a solvent-based solution or an aqueous latex) sandwiched between layers of PVdC that is latex-based (applied as two separate layers to cover pinhole-type defects); (2) PVAc latex-based layer sandwiched between layers of PVdC that is latex-based (this second system is water-based); and (3) terpolymer blended with an aqueous latex, which could be vinyl latex, vinyl acrylic or all acrylic.

Considering one embodiment of a film, a hybrid barrier film that combines a PVOH-based terpolymer and PVdC latex is used to achieve MVTR and OTR at the 10⁻¹ level (expressed in g (or cc)/m² day). This will result in a low-cost, transparent replacement for opaque foil and/or SiOₓ-coated film. This barrier system can be coated on nearly any substrate, and should exhibit better “flex-crack” resistance that films produced with inorganic materials.

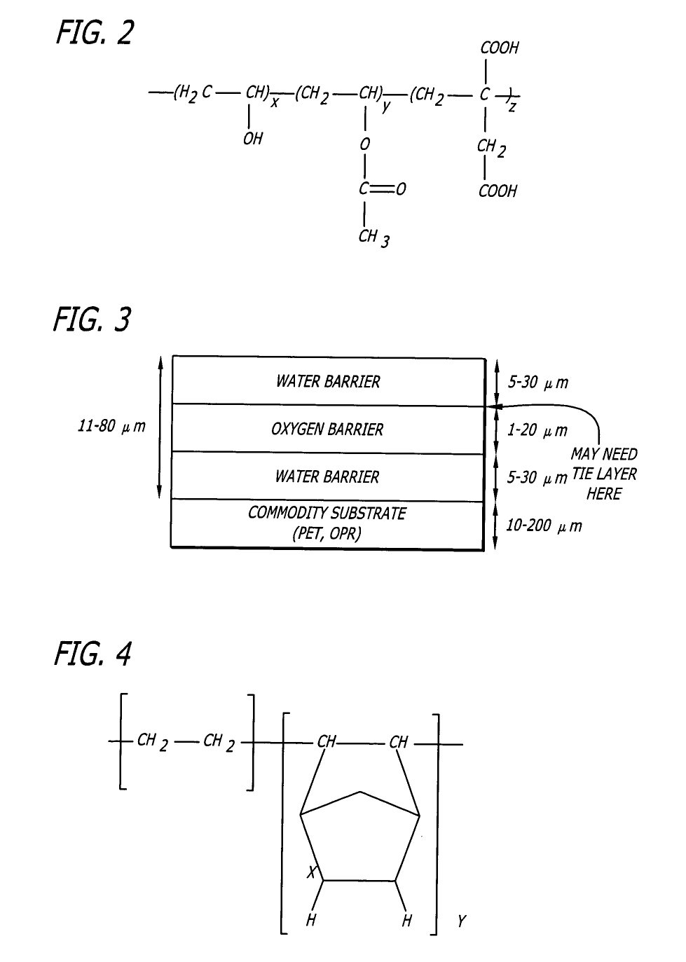

At the present time, oxygen and water barrier are supplied by two different chemistries. The oxygen barrier is provided by a terpolymer of vinyl alcohol (VOH), vinyl acetate (VAc), and itaconic acid (IA). FIG. 2 shows the chemistry of the terpolymer, in which the precise values of x. y, and z are not known. This polymer is especially slow to dissolve in “neutral water”, requiring a minimum of 24 hours at 80 degrees C. to create a homogenous 10 wt % aqueous solution. It is the presence of the water-insoluble vinyl acetate that hinders solution formation. Both the vinyl alcohol and itaconic acid contribute to the low OTR values observed for this terpolymer. the mechanism of oxygen blockage is likely linked to the strong hydrogen bonding that is exerted by dry conditions (0% RH), this film has produced OTR values below 0.005 cc/m² day (0.00032 cc/100 in2 day) at 35 degrees C. (95 degrees F.). At 90% RH, the OTR increases to 2.5 cc/m2 day (0.16 cc/100 in² day), using the generalized construction shown in FIG. 3. It is assumed that further increasing the thickness of the PVdC water barrier will potentially reduce this value, making this the best transparent, all-organic barrier film known to the inventors.

For one current full-construction, Topas is used as the interlayer shown in FIG. 3 which allows PVdC to be coated on top of the terpolymer. When PVdC latex is coated directly onto a dry terpolymer surface, dewetting and destabilization of the latex occurs, which results in a highly defective, film with poor barrier performance. Topas 8007 is a cyclic olefin copolymer (COC) (structure shown in FIG. 4), comprised of ethylene (x=65 mol %) and norbornene (y=35 mol %), with a T_{g} of 80 degrees C. This polyolefin is applied to a dry terpolymer layer as a toluene-based solution (approx. 17 wt % polymer in solvent). The terpolymer is not toluene-soluable, which diminishes the level of interaction between these two polymer systems during drying. topas is very water-resistant (WVTR=0,02-0,04 g/m² day at 23 degrees C. and 85% RH), allowing it to protect the terpolymer from atmospheric moisture that would degrade its oxygen barrier performance. The OTR of the terpolyumer is 48.1 cc/m² day (3.1 cc/100 in² day), at 35 degrees C. and 90% RH, without Topas protection.

As suggested in FIG. 3, PVdC is the current top layer of a preferred barrier construction. Most traditional polymers show poor barrier performance to both water and oxygen, but a select group have either a low OTR (e.g. PVOH, EVOH) or MVTR (e.g. COC). PVdC is a unique polymer due to its combination of relatively low OTR(<1 cc, 0.1-0.2 day at 23 degrees C. and 0% RH) and properties is due to a combination of high crystallinity and high polarity. Two layers are typically coated together to eliminate pinholes that are exposed after the first layer is coated. Given the same total layer thickness of PVdC, a one-coat layer may have an MVTR that is an order of magnitude greater than a two-coat layer.

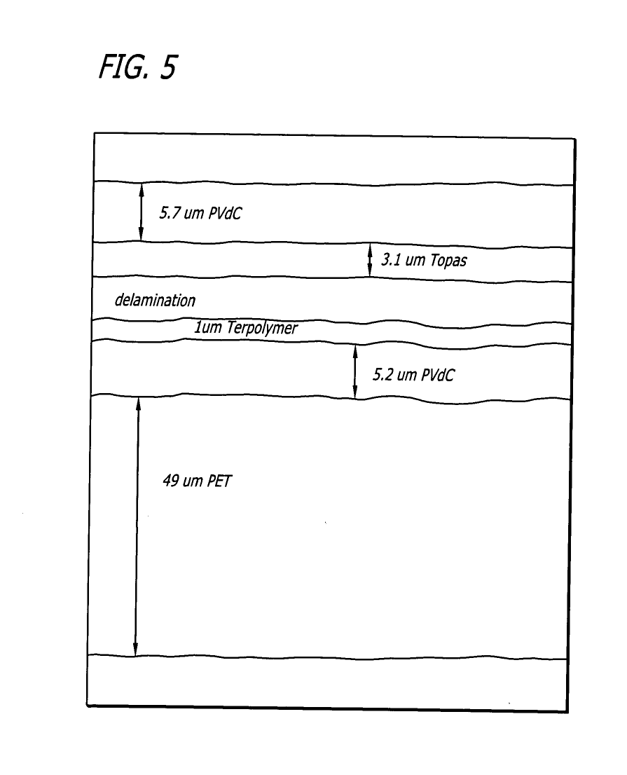

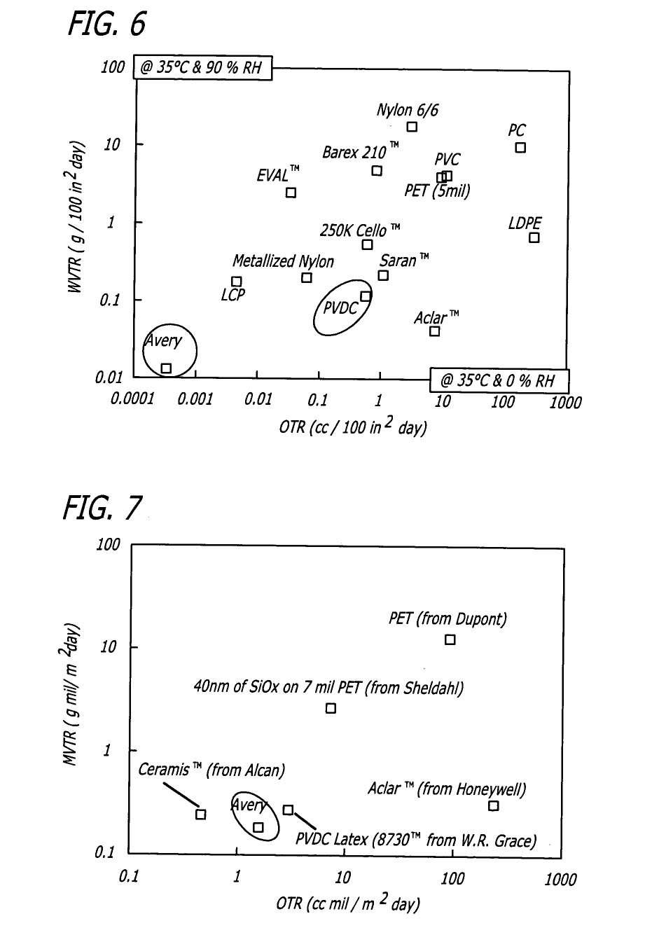

FIG. 5 shows an optical microscope cross-section of the PVdC/Terpolymer/Topas/PVdC full-construction. From this image, it can be seen that without delamination the full construction is approximately 15 mm thick (or 0,6 mil.). Although the target film thickness was 1 mil, this film has an MVTR of 0.33 g/m² day at 35 degrees C. and 90% RH. Under these same high humidity and temperature conditions this film has an OTR of 2.5 cm³/m² day. Presumably these barrier numbers could be decreased by a factor of two, at minimum, by making the same construction with a 1 mil thickness.

The oxygen and moisture barrier performance of the current full construction is comparable or better than most other competitive packaging films (including metalized, SiOx, extruded, and multilayer) are shown, but the OTR numbers were measured at 0% RH. Most systems show elevated barrier values at elevated humidity, as can be seen in FIG. 7. Keep in mind that the units are different in these two figures and English units (g/100 in² day) must be multiplied by 15.5 to convert them to SI units (g/m²). The only film that seems to have a better combination of OTR and MVTR than the present film is the Ceramis construction, which is an SiOx-coated OPP laminated to PET (total film thickness is 3.78 mil).

Interlayer Adhesion

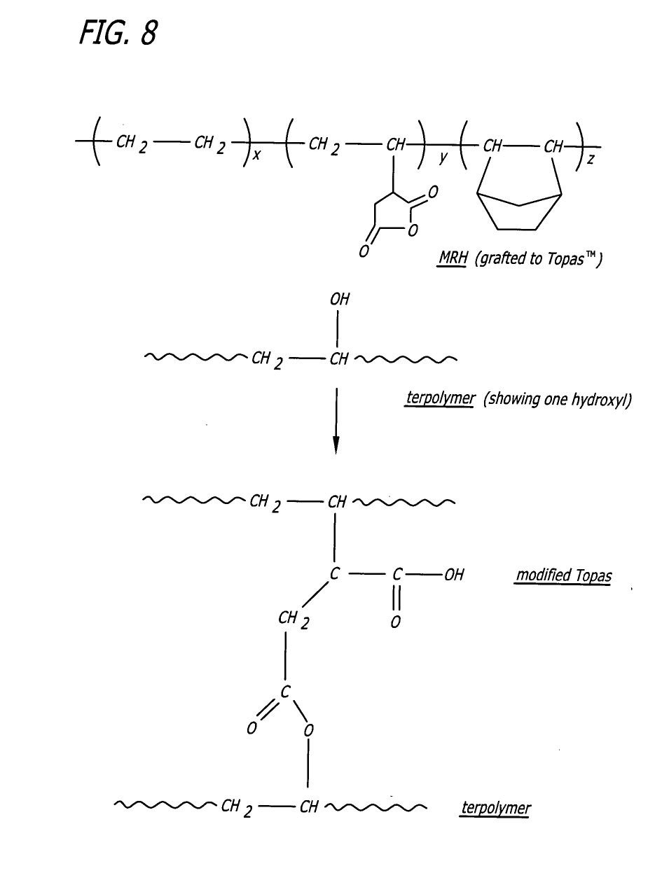

Modification of Topas with an anhydride (e.g., maleic anhydride (MAH)) is one possible way to strengthen the bond with the terpolymer. The polyethylene portion of Topas could be maleated prior to coating onto the terpolymer and then the MAH groups would react with the hydroxyl groups on the terpolymer to enhance interlayer adhesion (see FIG. 8). Another solution would be to replace Topas with another type of tie layer. Solvent-based PVdC, solvent-based PVAc, vinyl-actrylic latex and PVAc latex are all potential candidates for this alternate layer. An initial construction using PVAc latex in place of Topas also failed a tape test based upon thickness measurements, but barrier properties were unaltered and no corona treatment was required prior to applying the PVdC top layers. In the case of Topas, PVdC latex cannot wet the film without first corona treating. Corona treatment of the terpolymer layer prior to Topas application was also considered, but the fire hazard associated with corona treating in the presence of solvent nullified this option. It is possible that the terpolymer layer could be corona-treated with an aqueous (e.g. latex) tie layer. FIG. 8 is a schematic of the reaction between maleated topas and the hydroxylated portion of the terpolymer.

OTR Improvement

Simply increasing the thickness of the PVdC layers in the construction shown in FIG. 5 would lower the OTR of the full construction, but most likely by only a factor of two. In order to obtain an order of magnitude reduction in OTR, additives (e.g. clay) or new chemistry must be used. By adding clay platelets to the terpolymer solution, at a concentration below 5 wt % in the dry film, the OTR of this layer could potentially be reduced by an order of magnitude. Alternatively, replacing the terpoluymer with a linear regio-regular ethylene-vinyl alcohol (EVOH), produced suing ring opening metathesis polymerization (ROMP), could reduce the current OTR from 100 to 10⁻¹ (or even 10⁻²) cm³/m² day under high humidity conditions (Banslaben et al., U.S. Pat. No. 6,203,923). This regio-regular EVOH has an OTR two orders of magnitude lower than that of standard EVOH due to enhanced crystalinity. In fact, a one mil thickness film of this special EVOH could be coated with one mil of PVdC to produce a packaging film with MVTR and OTR in the 10-2 range (in SI units). Another simple method for improving OTR of the standard PVdC-based construction is to age the film prior to testing. Aging is a process by which the PVdC layer is able to increase its level of cystallinity. A room temperature aging study has already produced a film with an OTR of 0.55 cc mil/m² day.

It should be noted that interlayer adhesion is much stronger with an all emulsion-based or water-based to be more accurate full construction. This is likely due to partial solvation of the interface between the layers during coating and drying.

Emulsion-Based Full Constructions

High barrier multilayer constructions that can be produced using only latex-based layers have the advantage of being both economically and environmentally friendly. In this case, PVdC latex is still used as the low MVTR starting material, but the terpolymer is replaced with poly(vinyl acetate) latex. PVAc latex can be used at much higher solids than the terpolumer (55 wt % vs. 10 wt. %), which greatly enhances the thickness that can be generated without changing gravure cylinders. Furthermore, a PVAc latex-based film can be wet by PVdC latex without the use of a tie layer, which reduces the cost and the number of interfaces that need to be adhered.

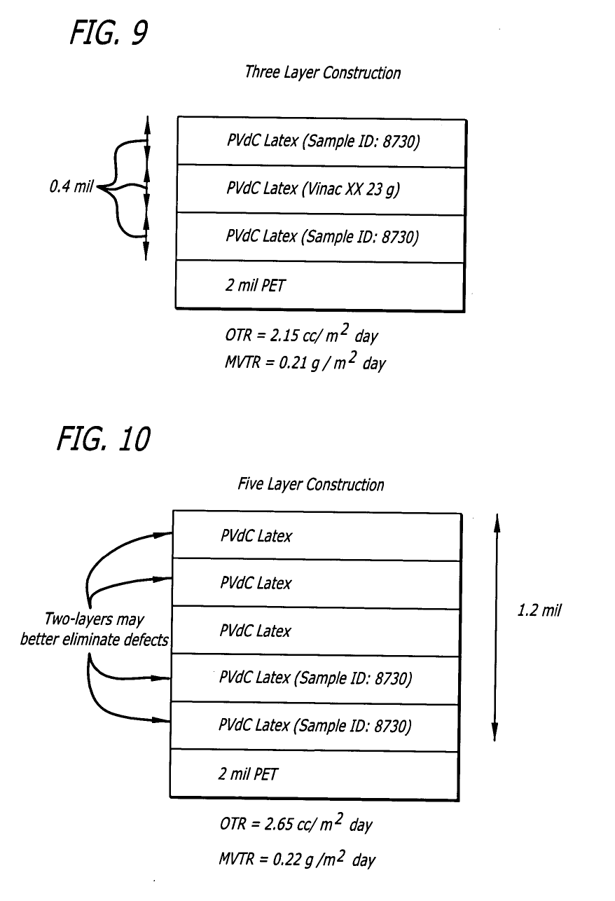

Another option involves blending terpolymer and a PVAc (or other commodity polymer) latex together and coating onto PVdC and capping with another layer of PVdC, which also eliminates the need for a tie layer and provides enhanced oxygen barrier. The effect of relative humidity on the OTR of a 5 micrometer layer of PVAc is currently being evaluated and the results will be compared to the same study done with a 5 mm film of terpolymer. It is believed that at elevated humidity (>35%) the PVAc will have a much lower OTR than the terpolymer due to its lack of water-solubility. Initial OTR results at 35 degrees C. and 90% RH, for three- and five-layer sandwich films (FIG. 9), seem to indicate that all-emulsion barrier films perform just as well as terpolumer-based versions, but are much more attractive from an economic and production standpoint. Aging of this film could potentially cut the OTR and MVTR numbers shown in half.

Barrier Film Commercial Production

Multilayer barrier constructions have been produced on a commercial scale using reverse-cylinder gravure coating, but other forms of roll-to-roll coating could also be employed (e.g. die-coating, curtain coating, etc.). Prior to coating the PVdC latex, it is filtered six time through a 1 micrometer filter bag to remove microscopic gel particles that tend to degrade the film's appearance. Terpolymer and any tie-layer that may be used are also filtered through 5 micrometer bags to remove grit and gels. these impurities could potentially create localized low barrier spots in the film. Currently, terpolymer coating is the rate-limiting layer and cannot be successfully coated faster than 800 ft./minute due to inadequate drying. By increasing the solids of the terpolymer formulation or with latex blending (as already mentioned), this coating rate could be increased to 1200 ft/minute or more. Another method of film production involves laminating separate films of terpolymercoated PVdC and PVdC-coated commodity substrate (e.g. PET, OPP, etc.). This would again result in a sandwich construction with the oxygen barrier between water-barrier layers.

Synergistic Copolymer Composition with High Gas Barrier

We turn now to a water-based, fast curing coating composition which provides high barrier against oxygen and moisture permeation. In one embodiment, the coating comprises special PVDC copolymer compositions with good oxygen barrier (OTR<1 cc/m² day) and high moisture barrier (MVTR<0.5 g/m² day). As one example, the coating may be used to produce a flexible, high clarity, barrier film for packaging.

The coating includes special synergistic components to combine with vinylidene chloride to form high gas barrier crystalline PVDC copolymer layer on flexible plastic film surfaces. Among the components helpful for enhancing PVDC gas barrier performance, methyl acrylate and methyl methacrylate were identified as the most effective ones at room temperature as well as elevated temperatures (e.g. approx. 40° C.).

Water emulsion or latex of these P(VDC-co-MA) and P(VDC-co-MMA) compositions also showed exceptionally efficient water desorption as monitored by TGA, which is crucial in obtaining high barrier coating under high speed, roll-to-roll continuous operation conditions.

Considering in particular embodiments that incorporate PVDC, the inventors have found that PVDC latex blends with the proper combination of copolymer components exhibited superior water vapor barrier properties, with Mocon water transmission rate lower than 0.05 g/m² day achieved on 5 mil thick PET film substrates. There is a clear dependency of copolymer components on affecting PVDC latex coatings' water barrier performance. Methyl acrylate and butyl acrylate were the two copolymer components most effective in enhancing water barrier. PVDC latex coating compositions with high oxygen barrier performance were also identified. Mocon oxygen transmission rate of 0.23 cc/m² day has been achieved on 2 mil thick PET film substrates. The copolymer component with the most significant effect on improving OTR was found to be methyl methacrylate.

Considering now copolymer and hybrid blend formulations, rapid removal of water from PVDC latex based coatings at peak temperatures below 110 degrees C. has been found possible. P(VDC-co-MMA) based coatings on 2 mil PET reached 40 degrees C. WVTR level of 0.2-0.3 g/m² day by using a 2-5 minutes heating profile at 108 degrees C. Silicone and fluorine based coupling agents were formulated into PVDC based coatings in both the hybrid composite form and the sequential layer deposition configuration. WVTR data collected so far indicates that the sequential layer configuration has the highest barrier performance.

### EXAMPLE 1

Determination of Oxygen Gas Transmission Rate—“A-90 @ 40C, 90% RH”

One film construction (“A90”) was analyzed by the OX-TRAN 2/20 (ML System) instrument to ASTM F1927 to determine the oxygen gas transmission rate. An approximate 4″ by 4″ piece of construction was used. The surface area of the sample tested was 50.00 cm². The instrument was operated at 40 degrees C. The analysis relative humidity was 90%. The permeant was oxygen. The flow rate was 20 sccm of oxygen gas. The sample underwent a one-hour conditioning period. The exam time for each cycle was 45 minutes.

Equilibrium was reached when the transmission rate varied between examinations by less than 1%. The steady-state after introduction of the oxygen gas into the test-gas side of the diffusion cell took approximately 24 hours.

The reported unit of measure was cc/m²-day). The minimum rate achievable was 0.005 cc/(m²-day) with a 50.00 cm² film. The bias for this test method was determined at 15% and was derived from comparisons with a known-value reference film. The precision was better than 10% relative.

With respect to the coating thickness and temperature ranges for the PVDC copolymer coatings, the dry PVDC coating thickness may fall within the range of 0.1 mil (2.5 microns) to 5 mils (125 microns). The preferred range is typically between approximately 0.5 mils to 2 mils. The effective curing temperature range may be between 70° C. to 160° C., with a preferred curing temperature of approximately 100°-120° C., and a curing time of approximately 1 to 5 minutes.

As alternatives, the coating of the same composition can be repeated more than once. At each pass, a lower coat weight or coating thickness can be applied. This multiple-pass coating approach reduces coating defects, and it can also speed up the drying and curing rates. The curing can also be done in multiple segments. For example, a high-temperature short cure may be followed by off-line aging at room temperature or a second cure at different temperatures to further complete the crystallization.

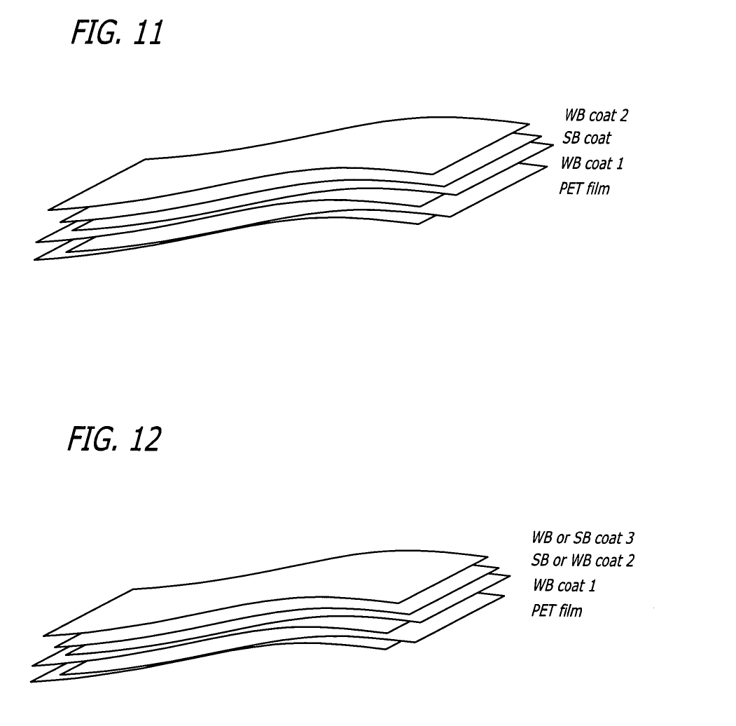

The oxygen (O₂) barrier coating materials (for example, WB Coat 1 on FIG. 11) are typically water soluble, and may include for example, PVOH-based co- or terpolymers, ethylene vinyl alcohol based copolymers (such as Soarnol by Nippon Gohsei), and/or materials that contain hydrophilic functional groups such as —OH, —NH, amide, as well as zwitterionic moiety, etc. The oxygen barrier coating is typically coated onto a clear film, although in alternative embodiments the film may be translucent or opaque.

Considering further FIG. 11, a solvent-based or water-based coating (SB or WB Coat 2) may serve to protect WB Coat 1. In that arrangement, WB Coat 2 may also function as a barrier material for moisture or oxygen. The formulations of Coat 2, as well as the coating processes and conditions employed to apply Coat 2, will typically not negatively impact on the barrier performance of WB Coat 1.

A solvent-based protective Coat 2 is typically formulated with hydrophobic polymers and an organic solvent. The hydrophobic polymers include, but are not limited to, the following materials: cyclo-olefin polymer (such as Zeonex and Zeonor by Nippon Zeon Co.), Topas brand polymers, PVDC (such as Saran F-resins), and fluoropolymers.

Barrier properties for moisture or oxygen may be enhanced further by adding an additional layer (Coat 3 on FIG. 12). The coating materials for Coat 3 may be, for example, either water based or solvent based. Some preferred coating materials include PVDC latex coating or PVAc latex coating.

The coatings typically have advantageous synergetic effects. For instance, the synergy effect between the Topas layer and the terpolymer layer, or the Topas layer and the PVDC latex coating layer, may enhance both oxygen and moisture barrier properties.

Considering additional exemplary details, a transparent barrier film construction may be made via a liquid coating process. The coating may be done continuously onto a substrate via a conventional wet coating technology known in the art. The coating process may result in a dual-layered, or alternatively a multi-layered, structure.

It is further noted that tie layers or primer layers can be used between each of the corresponding contact layers. It is also noted that constructions using one of the coatings, such as the oxygen barrier coating or the moisture barrier coating, and not both coatings in combination, may be made. The individual coatings may alternatively be combined with other coatings to provide specific properties for particular applications.

While the specification describes particular embodiments of the present invention, those of ordinary skill can devise variations of the present invention without departing from the inventive concept. For example, films having desirable oxygen barrier properties may have a wide variety of applications, such as in aerospace. For instance, an aircraft or spacecraft cabin may be lined with one or more layers of film as supplemental means to seal the cabin. Similar applications arise with respect to watercraft, in which it is desirable to protect portions of the watercraft from moisture. Consequently, the disclosure itself is presented by way of example rather than of limitation.

We claim:

1. A barrier film comprising:
a substrate film; and
means for improving at least one of the moisture barrier properties and oxygen barrier properties of the substrate film.

2. A barrier film as defined in claim 1, wherein the barrier film comprises a film coated with at least one of an aqueous solution and an organic solution.

3. A barrier film as defined in claim 2 further comprising a PVDC coating.

4. A barrier film as defined in claim 1, wherein the means for improving the oxygen barrier properties of the substrate film comprises at least one of the group constituting PVOH-based co-polymers, PVOH-based terpolymers, ethylene vinyl alcohol based copolymers, and materials that contain hydrophilic functional groups.

5. A barrier film as defined in claim 1, comprising a PVOH-based terpolymer, said terpolymer being covered by a tie layer to promote wefting, said terpolymer being sandwiched between layers of latex-based PVdC.

6. A barrier film as defined in claim 1, comprising a PVAc latex-based layer, said PVAc layer being sandwiched between layers of latex-based PVdC.

7. A barrier film as defined in claim 1, comprising a terpolymer; said terpolymer being blended with an aqueous latex.

8. A barrier film as defined in claim 1, wherein the film comprises a substrate film, a first water barrier layer, an oxygen barrier layer, and a second water barrier layer.

9. A barrier film as defined in claim 8, wherein the first water barrier is between 5 and 30 micrometers in thickness, the oxygen barrier is between 1 and 20 micrometers in thickness, and the second water barrier is between 5 and 30 micrometers in thickness.

10. A barrier film as defined in claim 8, wherein the first and second water barrier layers comprise PVdC and the oxygen barrier comprises PVAc.

11. A barrier film as defined in claim 8, wherein the first and second water barrier layers each comprise two sublayers.

12. A barrier film, as defined in claim 1, comprising at least one of a PVOH copolymer and a PVOH terpolymer, the PVOH-based polymer being blended with clay.
